(19) United States
(12) Patent Application Publication
(10) Pub. No.: US 2010/0005193 A1
(43) Pub. Date: Jan. 7, 2010

(54) DEVICES AND SYSTEM OF INTERCONNECTING SUCH DEVICES IN A FAULT-RESISTANT TOPOLOGY

(75) Inventors: Edmund Alexander, Hordt (DE); Werner Becherer, Hemhofen (DE); Dan Jakominich, Herzogenaurach (DE); Christian Schwarz, Zirndorf (DE); Georg Stein, Nurnberg (DE)

Correspondence Address: Henry M. Feiereisen;Henry M. Feiereisen, LLC, Suite 4714, 708 Third Avenue, New York, NY, 10017, US

(73) Assignee: Siemens Aktiengesellschaft, Munchen (DE)

(21) Appl. No.: 12/168,467

(22) Filed: Jul. 7, 2008

(51) Int. Cl. G06F 15/16

(52) U.S. Cl. 709/239

(57) ABSTRACT

A device for measuring a physical quantity in a wired electrical network, such as a local area network (LAN) or Ethernet, has a unique network address and a first interface connected to a wired network and configured to receive and transmit data. To reduce costs for materials and the complexity of cabling, the device further includes a switch for connection to an additional device and for forwarding data, preferably in the form of data packets, to the additional device. A system includes several such devices, arranged in a chain or ring topology, and can forward data to other such devices based on the device addresses. The disclosed device configuration eliminates expensive and difficult to install switches frequently required in the center of a star configuration.

### CROSS-REFERENCES TO RELATED APPLICATIONS

None

### BACKGROUND OF THE INVENTION

The invention relates to a device for measuring a state or a physical quantity in a network, in particular an electrical network, and a system of such devices which are interconnected for data and power communication in a fault-resistant topology.

Nothing in the following discussion of the state of the art is to be construed as an admission of prior art.

Devices for measuring electrical signals are, for example, Power Monitoring Devices (PMD) or switching devices configured for communication. Such devices are used, for example, in a low voltage power distribution system. The PMDs can be networked using 10/100/1000 Base Tx/Sx/Fx Ethernet networks. The network topology normally requires a separate Ethernet switch/Ethernet hub (or a converter “Ethernet to Serial Gateway”) which is typically located in a corresponding control box. For each PMD, a corresponding line (communication link) extends from the Ethernet switch to the Ethernet interface of the device representing a terminal, either in a star or a tree structure with the Ethernet switch as a center.

Disadvantageously, in the event that the Ethernet switch fails, the communication between all connected PMD's also stops. Moreover, the large number of networked devices which are in part installed in high density in a switch gear or switch board requires a substantial amount of cabling and requires complex wire routing.

Accordingly, there is a need to lower the risk for a complete communication failure of the interconnected devices and to reduce the amount of cabling and installation costs.

### SUMMARY OF THE INVENTION

According to one aspect of the invention, a device for measuring a physical quantity in an electrical network includes a first interface connected to a wired network and configured as a terminal receiving and transmitting data via the first interface, wherein the device has a unique network address, and a switch configured for connection with a first interface of at least one additional device and for forwarding data to a first interface of the additional device.

According to another aspect of the invention, a system of devices capable of measuring a physical quantity of a network are interconnected. Each of these devices includes a first interface configured as a terminal receiving and transmitting data via the first interface and having a unique network address, and a switch configured for forwarding data to a first interface of another device.

The devices are interconnected in form of a chain and configured to forward data addressed to another of the devices to the other device. The switch of each device in the chain is connected to a first interface of an adjacent device in the chain.

With this approach, the communication interface has now a switching functionality. In this way, a linear structure (connection) is generated similar to a chain, which significantly reduces the quantity of material required for cabling and lowers the cabling costs. Also eliminated are expensive switches operating in a star configuration which cause increased installation costs.

Embodiments of the invention may include one or more of the following features. The measured physical quantity may represent a state of the network or a state of a device in the network. The network may be a local area network (LAN), for example, an Ethernet, with data being received and transmitted in form data packets. The switch may be integrated in the device or may be a module connected to the device.

The switch may be configured to supply a connected additional device with electric energy and/or to receive electric energy from a connected additional device. The device may include measurement inputs for receiving input signals representing the physical quantity, and may further include a digitizer and a software-controlled processor connected downstream of the digitizer. The input signals may represent a physical quantity in an energy distribution network.

In the system, a first of the interconnected devices in the chain may be connected with its first interface to a wired network via a main data line and a last of the interconnected devices in the chain may be connected with its switch to a redundancy line such that the devices form a ring. The interconnected devices forming the ring may be configured to identify and process redundant data packets.

The configuration of an exchange device which replaces a device in the chain, may be configured, i.e., supplied with configuration parameters, by at least one of the interconnected devices, for example, by the immediately adjacent device in the chain, thus making it unnecessary to configure a device for communication centrally or externally.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows two interconnected devices according to the invention, and

FIG. 2 shows a system with a plurality of interconnected devices according to the invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

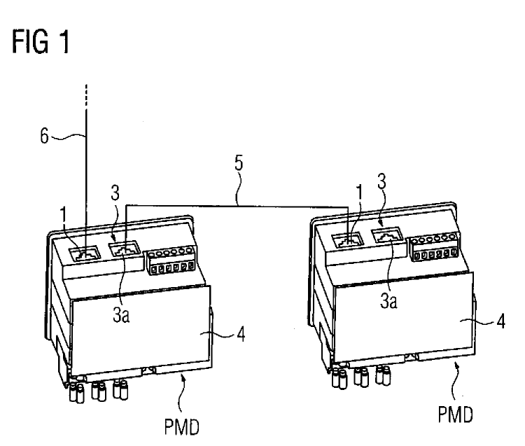

Turning now to the drawing, and in particular to FIG. 1, there are shown two devices, in particular Power Monitoring Devices (PMD), connected with one another via an Ethernet connection. However, the devices can also include power switches, safety disconnect switches with a measurement device, as well as motor protection devices in low voltage distribution circuits, etc. Without limiting the scope of the invention, all devices in the figures are shown as PMD's and have in the figures the designation PMD. The PMD devices are generally used to measure state parameters and physical quantities in electrical networks and in the present example, more specifically to determine and output analog electric signals in an energy distribution network (not shown). The signals represent electrical voltages and currents at defined measurement points of the energy distribution system, with the voltages being applied to measurement inputs of the PMD devices. Each PMD device includes a digitizer to which the signals are applied. The signals are subsequently digitally processed in a downstream software-controlled processor (not shown).

The PMD devices are provided with a (first) Ethernet interface 1, i.e., a communication interface for a wired local Ethernet data network (LAN) configured to receive and transmit data, in particular digital signals, in form of data packets (telegrams). Each PMD device has a unique address. A PMD device receives only those data packets that are addressed to the particular PMD device.

The PMD devices can also be connected via the Ethernet interface 1 as so-called terminals which then communicate via the Ethernet interface 1 in a manner known in the art.

Each PMD device also includes a switch 3 (which may not be a physical switch, but a switching functionality implemented in the device). The switch 3 can be used to connect one of the PMD devices with the (first) Ethernet interface 1 of another PMD device. The switch 3 may be integrated in the PMD device and is connected to the (first) Ethernet interface 1 via additional Ethernet interfaces 3a (only one additional Ethernet interface 3a is shown in the Figures), which are also configured as Ethernet interfaces. The Ethernet interfaces integrated in the PND device are arranged inside the housing 4 of the PMD device. For this reason, only the Ethernet interface 3a of switch 3 is illustrated in FIG. 1. The Ethernet interface 3a can also be implemented as a module mounted on the housing 4 of the PMD device.

Several PMD devices can be linearly connected with one another via the switch 3 to form a chain, also referred to as Daisy Chain.

FIG. 1 shows only two connected PMD devices representing the smallest possible chain. The switch 3 of the PMD device on the left side is here connected via the Ethernet interface 3a with the Ethernet interface 1 of the PMD device on the right side. The connection is implemented with a cable 5.

The Ethernet interface 1 of the left PMD device in the chain of the two PMD devices illustrated in FIG. 1 is connected to a data trunk line 6, also referred to as trunk cable.

The Ethernet interfaces 3a can be “Power-over-Ethernet”-enabled, i.e., they can be configured to provide auxiliary power to a connected PMD device in the chain. An additional aspect of this invention extends the standard “Power-over-Ethernet”, wherein each interface can both provide and receive auxiliary power. The Ethernet interfaces 3a of PMD devices in the chain then continue to operate even if a PMD device, i.e., a PMD component in the chain, fails. In particular, the Ethernet interfaces 3a may remain operational even if a PMD is non-functioning or if the switch is configured as expansion module.

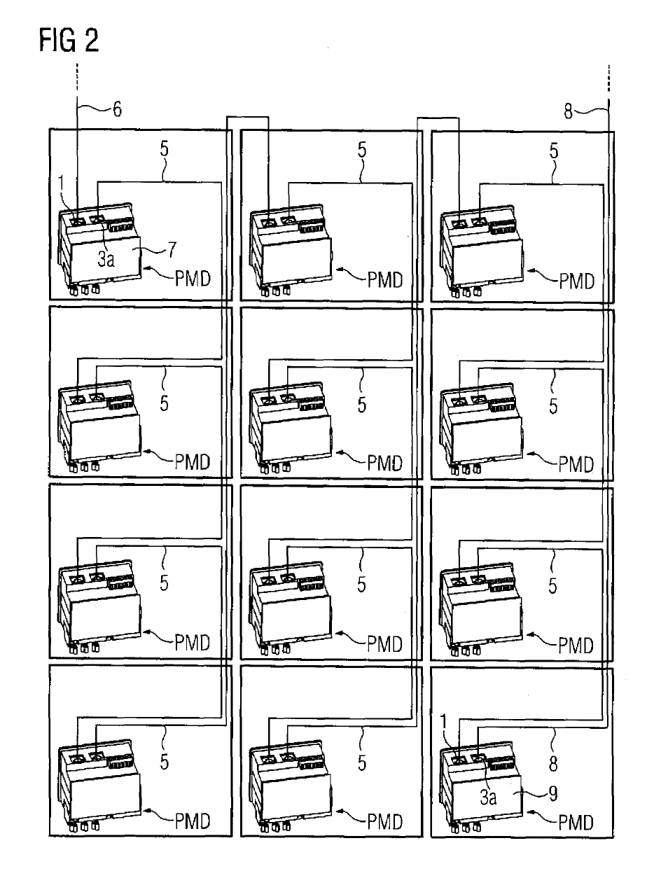

FIG. 2 shows a system of interconnected PMD devices. In this embodiment, the first PMD device of the chain with the reference symbol 7 is connected to the data trunk cable 6.

The PMD devices in the exemplary arrangement depicted in FIG. 2 can process redundant data packets, i.e.,
a) they identify and delete their own transmitted data packets, and
b) they identify and ignore duplicated data packets, i.e., data packets transmitted via the redundant path.

As shown in FIG. 2, several devices (PMD) forming a chain can also be interconnected to form a ring by adding a redundant line 8 which is connected to the Ethernet interface 3a of the last PMD device in the chain, designated with the reference numeral 9. The redundant line 8 and the data trunk cable 6 can also be connected to an external Ethernet switch (not shown) operating as a redundancy manager or can use a MRP protocol (Media Redundancy Protocol). The PMD devices and their interfaces 1, 3a are therefore capable of managing redundant data blocks generated by the ring topology.

When a PMD device is exchanged, i.e. replaced, then the new PMD device replacing the old PMD device is automatically configured by at least one other, i.e. existing PMD device in the chain, in particular by the immediately adjacent PMD device. The automatic configuration configures both the communication parameters and the settings.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A device for measuring a physical quantity in an electrical network, comprising:
a first interface connected to a wired network and configured as a terminal receiving and transmitting data via the first interface, said device having a unique network address, and
a switch configured for connection with a first interface of an additional device and forwarding data to a first interface of the additional device.

2. The device of claim 1, wherein the data are received and transmitted in form data packets.

3. The device of claim 1, wherein the physical quantity represents a state of the network or a state of a device in the network.

4. The device of claim 1, wherein the network is a local area network (LAN).

5. The device of claim 4, wherein the network is an Ethernet.

6. The device of claim 1, wherein the switch is integrated with the device.

7. The device of claim 1, wherein the switch is a module attached to the device.

8. The device of claim 1, wherein the switch is configured to supply a connected additional device with electric energy or receive electric energy from a connected additional device.

9. The device of claim 1, further comprising measurement inputs receiving input signals representing the physical quantity, and a digitizer and a software-controlled processor connected downstream of the digitizer.

10. The device of claim 9, wherein the input signals represent a physical quantity in an energy distribution network.

11. A system of interconnected devices, each of the devices comprising:
a first interface configured as a terminal receiving and transmitting data via the first interface and having a unique network address, and
a switch configured for forwarding data to a first interface of another device,
wherein the devices are interconnected in form of a chain and configured to forward data addressed to another of the devices to the other device, with the switch of each device in the chain being connected to a first interface of an adjacent device in the chain.

12. The system of claim 11, wherein a configuration of an exchange device which replaces a device in the chain, is configured by at least one of the interconnected devices.

13. The system of claim 12, wherein the configuration of an exchange device which replaces a device in the chain, is configured by an immediately adjacent device in the chain.

14. The system of claim 12, wherein the configuration comprises configuration parameters.

15. The system of claim 11, wherein a first of the interconnected devices in the chain is connected with its first interface to a wired network via a main data line and a last of the interconnected devices in the chain is connected with its switch to a redundancy line such that the devices form a ring, and wherein the interconnected devices forming the ring are configured to identify and process redundant data packets.

16. The system of claim 15, wherein the main data line and the redundancy line are connected to a redundancy manager.

17. The system of claim 15, wherein the main data line and the redundancy line use a media redundancy protocol (MRP).
